(19) United States
(12) Patent Application Publication
(10) Pub. No.: US 2025/0277625 A1
(43) Pub. Date: Sep. 4, 2025

(54) METHOD AND SYSTEM FOR WASTE-HEAT RECOVERY

(71) Applicants: IAF Process Engineering GmbH, Frauental an der Laßnitz (AT); Mondi AG, Vienna (AT)

(72) Inventors: Christian HUBER, Deutschlandsberg (AT); Mario PENASO, Preitenegg (AT)

(73) Assignees: IAF Process Engineering GmbH, Frauental an der Laßnitz (AT); Mondi AG, Vienna (AT)

(21) Appl. No.: 18/858,375

(22) PCT Filed: Apr. 19, 2023
(86) PCT No.: PCT/AT2023/060132

§ 371 Date: Oct. 21, 2024

(30) Foreign Application Priority Data
Apr. 20, 2022 (AT) A 50263/2022

(51) Int. Cl. F26B 23/00; F23G 5/46; F26B 23/02

(52) U.S. Cl. CPC F26B 23/001; F23G 5/46; F26B 23/02; F23G 2206/20

(57) ABSTRACT

The invention relates to a method for waste-heat recovery comprising the following steps: providing a first process unit (10), which requires thermal energy, wherein the first process unit (10) comprises a heating burner (15, 16), which is fluidly connected to a fuel supply line (100, 101, 102) and to a combustion-air supply line (112, 113); providing a second process unit (20), in which thermal energy is generated, wherein the second process unit (20) comprises a combustion furnace (21), which is designed to burn waste materials (201) containing sulfur compounds; burning waste materials (201) containing sulfur compounds to generate hot combustion exhaust gas (210) which contains sulfur compounds; discharging the hot combustion exhaust gas (210) from the second process unit (20) and introducing the combustion exhaust gas (310) into a waste-heat recovery device (3) comprising a waste-heat exchanger (31, 32); transferring thermal energy from the combustion waste gas (310) by the waste-heat exchanger (31, 32) to a fluid which is used as an energy source in the first process unit (10), wherein a gas temperature (36, 37) of the combustion exhaust gas (311, 312) downstream of the waste-heat exchanger (31, 32) is set so as not to be below a dew-point temperature of the sulfur compounds in the combustion waste gas (311, 312).

### FIELD OF THE INVENTION

The invention relates to a method for waste-heat recovery for heating a heating burner, in particular a heating burner of a drying section of a paper machine. Further, in the context of the invention a system and a controller for waste-heat recovery between two process units, in particular between a combustor of a pulp mill and a drying section of a paper machine, is disclosed.

### PRIOR ART

It is known from the prior art that fossil primary fuels such as crude oil, natural gas, coal or coke are currently used as primary energy sources for process heating in numerous industrial production processes, in particular for very energy-intensive production processes. For example, paper production is an energy-intensive production process.

For paper production, a milled pulp-water mixture, a so-called pulp suspension, with a very high water content of usually around 98% to 99.9% water is usually applied evenly in a paper machine, wherein the moist pulp suspension is then mechanically dewatered to obtain a moist paper web, and wherein this paper web is then dried in a drying section, in which the paper web is passed over numerous heated drying cylinders. Depending on the construction of the paper machine used/depending on the paper grade or paper quality to be produced, the paper web in the drying section may, for example, be dried from a water content of around 50% to 60% water upstream of the drying section to a content of around 3% to 12% water downstream of the drying section, wherein the excess water is evaporated.

For example, in a so-called MG paper machine (MG: short for ‘machine-glazed’), which may be used to produce paper that is smoothed on one side, the drying section also comprises at least one large heated drying cylinder, the so-called ‘Yankee’ cylinder, which is also known as the “smoothing cylinder”. Due to the large cylinder diameter of the Yankee cylinder and the resulting very long dwell time of one side of the paper on the cylinder surface, the smoothness and gloss typical of MG papers is generated on the side of the paper facing the cylinder. The moisture from the paper is removed with a heated air flow from drying hoods in the area of the Yankee cylinder, wherein the water content of the paper web upstream of the Yankee cylinder is usually around 40% to 60% and downstream of the Yankee cylinder around 10%. In particular, the heating of this Yankee cylinder/smoothing cylinder is therefore particularly energy-intensive. Depending on the size of the paper machine, the heating output required to heat the Yankee cylinder alone may be in the magnitude of about 10 MW.

According to the prior art, the drying air required for the drying section of a paper machine is brought to the desired drying temperature by one or more heating burners, which are usually fired with natural gas, and to the desired residual moisture by recirculation.

In order to reduce production costs and minimise CO₂ emissions, there is a general need in industrial production processes to use the highest possible amount of secondary energy sources, which have the highest possible proportion of biogenic carbon and are therefore as CO₂-neutral as possible, instead of primary energy sources. Alternative substitute fuels/secondary fuels are all non-fossil fuels, for example fuels that are obtained from waste, wherein these may be solid, liquid or gaseous waste materials. For example, alcohols such as bioethanol, methanol, wood chips, pellets or tall oils can serve as CO₂-neutral substitute fuels/as secondary fuels.

Returning to the pulp and paper industry, numerous pulp mills already operate combustors to combust the waste materials generated during pulp production, for example bark waste, fibre sludges, sewage sludges, tall oils, turpentines, liquid methanol, rich gases and/or non-condensable waste gases (in short: NKG). Rich gases and non-condensable waste gases are waste gases from pulp production that include for example methanol and turpentine compounds as energy sources, as well as high concentrations of sulphur compounds, which is why these waste gases also have to be combusted in a combustor.

The most common methods for lignin breakdown in the cellulose matrix of wood chips are the sulphate process and the sulphite process. In particular, high concentrations of pollutants such as sulphur compounds and other oxides such as nitrogen oxides may be present in the combustion waste gas due to the bark waste, fibre sludge, rich gases and/or non-condensable waste gases (NKG) that originate as waste materials from pulp production and are used as alternative fuels for operating the combustor. In addition, high loads of resin acids, for example turpentine, which are present in the bark waste of coniferous woods and whose volatile compounds, for example monoterpenes, may also enter the combustion waste gas, must be taken into account. Turpentine is harmful to health and the environment. Pitch-like residues of tall oil, an oily mixture of substances that is the most important by-product in the production of pulp—more precisely: sulphate pulp, in particular when using pine wood-may also be used as an alternative fuel in the combustor. Tall oil is a black-yellow liquid that is mainly composed of fatty acids and resin acids as well as sterols and other substances. The composition varies greatly due to the origin of the processed resinous woods. The softening temperature of this natural resin, which varies considerably in quality, is generally between 80° C. and 120° C.

A gasification reactor in the form of a fluidised bed gasifier, for example, may be used as the combustion furnace of such an combustor. Such a gasification reactor, which is used for the combustion and gasification of the supplied fuels, is usually operated at temperatures of at least 850° C. Alternatively or in addition to this, liquid fuels and/or waste materials may also be burnt in a caustic combustion boiler, for example, which serves as a combustion furnace.

Due to the high pollutant loads present in the combustion waste gas after waste incineration, the hot combustion waste gas must undergo waste gas cleaning, for example flue gas scrubbing, before the appropriately cleaned waste gas may be released into the environment via a chimney.

Due to the problematic pollutants in the combustion waste gas from the combustor, the usually large spatial separation between the process unit of the paper machine, in particular the drying section of the paper machine, and the combustor of a connected pulp mill, as well as the difficulty in controlling the waste-heat quantities, waste-heat recovery between two process units, in particular between an combustor of a pulp mill and a drying section of a paper machine, has not been used to date.

### OBJECT OF THE INVENTION

It is therefore the object of the invention to overcome the disadvantages of the prior art and to propose a method for waste-heat recovery with which it is possible to reduce the previously necessary requirement for primary fuels for heating a heating burner, in particular a heating burner of a drying section of a paper machine, by saving fossil primary fuels and replacing them at least partially with non-fossil substitute fuels/secondary fuels with the highest possible proportion of biogenic carbon. Thus, the method according to the invention is intended to utilise heat energy, which was previously released into the atmosphere in the hot combustion waste gas, for at least partial substitution of primary fuels for heating a heating burner, in particular a heating burner of a drying section of a paper machine.

Further objects of the invention are to provide a system and a controller for waste-heat recovery between two process units, in particular between an combustor and a paper machine.

### DESCRIPTION OF THE INVENTION

These objects are solved by a method according to the invention for waste-heat recovery for heating a heating burner, in particular a heating burner of a drying section of a paper machine.

The method according to the invention for waste-heat recovery comprises the following steps:
providing a first process unit in which thermal energy is required in an operating state of the first process unit, wherein the first process unit comprises at least one heating burner, wherein the at least one heating burner is fluidly connected to at least one fuel supply line and to at least one combustion-air supply line;
providing a second process unit in which thermal energy is generated in an operating state of the second process unit, wherein the second process unit comprises a combustion furnace, which combustion furnace is designed to burn secondary fuels and/or waste materials including sulphur compounds in the operating state of the second process unit;
combusting of secondary fuels and/or waste materials including sulphur compounds in the combustion furnace of the second process unit to generate hot combustion waste gas, wherein the hot combustion gas includes sulphur compounds;
discharging the hot combustion waste gas from the second process unit, optionally with admixture of fresh air and/or tertiary air, and introducing the hot combustion waste gas into a waste-heat recovery device comprising at least one waste-heat exchanger;
transferring thermal energy from the hot combustion waste gas introduced into the waste-heat recovery device by the at least one waste-heat exchanger to a fluid used as an energy source in the first process unit, wherein a gas temperature of the combustion waste gas downstream of the at least one waste-heat exchanger within the waste-heat recovery device is set so as not to fall below a dew-point temperature of the sulphur compounds in the combustion waste gas.

Particularly advantageously, the waste-heat recovery method according to the invention can very efficiently transfer the waste-heat of the hot combustion waste gas of the combustion furnace of the second process unit in the form of thermal energy directly to a fluid used as an energy source in the first process unit by suitably interposing at least one waste-heat exchanger of the waste-heat recovery device. Gases, air, water or other liquids, liquid mixtures, oils, thermal oils and/or latent heat storage media, for example, may serve as the fluid/heat transfer fluid.

The fluid in the first process unit serves as a heat transfer medium and is heated as a result of the thermal energy supplied by the waste-heat exchanger, which may save the primary fuel otherwise required to generate the same amount of heat in the first process unit. Due to the sulphur compounds in the combustion waste gas, it is substantial to set the gas temperature of the combustion waste gas downstream of the at least one waste-heat exchanger within of the waste-heat recovery device so that the gas temperature is above the dew-point temperature of the sulphur compounds in the combustion waste gas. The composition of the sulphur compounds is largely dependent on the composition of the waste materials and fuels burned in the combustion furnace. A dew-point temperature range of hydrogen sulphide compounds in the combustion waste gas of about 120° C. to 130° C. may be assumed as a guideline.

Consequently, it must be ensured during process control that the gas temperature of the combustion waste gas in the waste-heat recovery device does not fall below this dew-point temperature of the sulphur compounds in the combustion waste gas in order to avoid undesirable separation of the sulphur-containing pollutants from the combustion waste gas in the waste-heat recovery device and the associated blockages and malfunctions.

The combustion furnace of the second process unit may be a waste incineration furnace.

By definition, a heat exchanger or heat transfer device is a device that transfers thermal energy from one fluid/material flow to another fluid/material flow. To emphasise its specific association with the waste-heat recovery device according to the invention, to which the at least one waste-heat exchanger is fluidly/fluidically connected, the at least one heat exchanger of the waste-heat recovery device particularly relevant here is referred to below as a waste-heat exchanger.

The position indications of parts or components of the system for waste-heat recovery used in the following, such as the terms ‘top’, ‘bottom’, ‘above’, ‘below’, ‘front’, ‘back’, ‘side’, ‘within’, ‘outside’ and the like, substantially serve to provide a better understanding of the invention, in particular to indicate the position or arrangement of the corresponding parts or components in connection with the following drawing. In any case, such positional details are known to the person skilled in the art and do not limit the present invention.

Further advantageous the embodiments and developments can be found in the dependent claims, as well as the description.

In an advantageous variant of the method of the invention, the gas temperature of the combustion waste gas downstream of the at least one waste-heat exchanger within the waste-heat recovery device may be set to at least 130° C., preferably to at least 135° C. Our own preliminary tests have shown that at gas temperatures of the combustion waste gas of at least 130° C., the pollutants included in the combustion waste gas, in particular the sulphur-containing pollutants included therein, do not yet condense and therefore the temperature is not below the dew-point temperature of these pollutants in the combustion waste gas. Undesirable deposits and caking on the equipment and pipework in contact with the combustion waste gas are therefore avoided.

As mentioned at the beginning, the softening temperature of various natural resins from bark waste, whose volatile components may also be present in the combustion waste gas, is generally between 80° C. and 120° C. Therefore, the aforementioned gas temperatures of the combustion waste gas of at least 130° C., preferably at least 135° C., in the waste-heat recovery device are also advantageous in order to prevent solid deposits and film formation of resins and terpenes and thus to ensure continuous operation of the waste-heat recovery device that is as undisrupted and maintenance-free as possible.

It may be particularly suitable if a paper machine, preferably a drying section of a paper machine, is provided as the first process unit in the method according to the invention. As emphasised at the beginning, paper production is particularly energy-intensive, which is why there is a particularly great need to implement measures for waste-heat recovery and saving primary fuels. As mentioned, the drying section of a paper machine is particularly suitable for replacing at least a portion of the thermal energy from heating burners for hot air generation, which is currently usually provided by natural gas firing, with the method for waste-heat recovery according to the invention in the form of waste-heat from secondary fuels.

The method according to the invention can be carried out particularly efficiently if an combustor of a pulp mill is provided as the second process unit, wherein the combustor is designed to burn secondary fuels and/or waste materials in the operating state, wherein the secondary fuels and/or waste materials are selected from the group comprising: wood chips, bark waste, fibre sludges, sewage sludges, methanol, bioalcohol, tall oils, turpentines, rich gases and/or non-condensable waste gases.

A process integration of a paper machine as the first process unit, which requires thermal energy during operation, and an combustor of a pulp mill as the second process unit, which generates thermal energy in the form of hot combustion waste gas, at the same site offers numerous advantages. Depending on the size of the combustor, heating capacities in the magnitude of 10 MW of thermal energy, for example, can be transferred from the hot combustion waste gas of the second process unit to a fluid of the first process unit.

The combustor may be a waste combustor, wherein the combustion furnace is a waste incineration furnace.

It may be particularly suitable if the fluid used as an energy source in the first process unit is combustion supply air for the at least one heating burner. Thermal energy is transferred from the hot combustion waste gas by the at least one waste-heat exchanger to the combustion supply air for the at least one heating burner in the first process unit, wherein the combustion supply air is heated.

In order to improve the heat transfer/to increase the amount of heat to be transferred and thus the heating capacity, it may be suitable to connect several waste-heat exchangers in series and/or to divide the heat transfer between several fluids, each of which is used as an energy source in the first process unit.

It may be particularly advantageous if, in the method according to the invention, a gas temperature of the hot combustion waste gas immediately upstream of the waste-heat recovery device, optionally with the admixture of fresh air and/or tertiary air, is set in the range from 550° C. to 650° C., preferably from 570° C. to 630° C., particularly preferably from 590° C. to 610° C.

The hot combustion waste gas temperature immediately downstream of the combustion furnace may, for example, be in a range of 850° C. to about 1,000° C., which is usually too hot for drying operations in the paper industry. Hot air temperatures in the magnitude of around 300° C. are usually required for paper drying in the drying section. Providing hot combustion waste gas in a range of 550° C. to 650° C., particularly preferably around 600° C., enables efficient heat transfer of large amounts of heat/large heat outputs to a fluid of the first process unit. For example, with this temperature spread/temperature difference between the two media on both sides of the waste-heat exchanger, combustion supply air for the at least one heating burner can be heated to a supply air temperature of around 300° C. in the at least one waste-heat exchanger, thus saving up to 90% of the amount of natural gas otherwise required to fire the heating burner and replacing it with CO₂-neutral energy sources. By admixing fresh air and/or tertiary air, for example in the form of exhaust air from another process unit, the aforementioned operating range of hot combustion waste gas of 550° C. to 650° C. can be set particularly conveniently.

The required thermal energy/heat energy from the combustion waste gas may be controlled, for example, by a slow bypass control. On the side of the circulating drying air, it may be suitable for reasons of simplified controllability if the smallest possible portion of the required heat energy continues to be generated by natural gas combustion.

In an advantageous development of the method according to the invention, the waste-heat recovery device may comprise at least one waste-heat recovery line for discharging the hot combustion waste gas from the second process unit, wherein the at least one waste-heat recovery line is fluidly connected to the second process unit and to the at least one waste-heat exchanger, preferably to at least two waste-heat exchangers connected in series one after the other, and wherein a flue gas purification apparatus is arranged downstream of the at least one waste-heat exchanger, so that the hot combustion waste gas in the operating state of the second process unit is conveyed through the at least one waste-heat exchanger, preferably through at least two waste-heat exchangers connected in series one after the other, and is cooled in the process before the combustion waste gas is purified in the flue gas purification apparatus.

Depending on the composition of pollutants in the combustion waste gas, a flue gas purification apparatus may be required, for example a flue gas scrubber and/or an electrostatic precipitator for dust precipitation.

This variant of the embodiment of the method according to the invention is particularly suitable as a solution for retrofitting existing combustors. Instead of a conventional waste gas line, in which the combustion waste gas from the combustion furnace passes directly into a downstream flue gas purification apparatus and is thus conducted away unused via a chimney, in the process control according to the invention the hot combustion waste gas may be conducted in at least one waste-heat recovery line, which is fluidically connected to the second process unit/to the combustion furnace and to the at least one waste-heat exchanger, preferably with at least two waste-heat exchangers connected in series one after the other.

The flue gas purification apparatus is arranged downstream of the at least one waste-heat exchanger, so that the hot combustion waste gas in the operating state of the second process unit is conveyed through the at least one waste-heat exchanger, preferably through at least two waste-heat exchangers connected in series one after the other, and is cooled in the process before the combustion waste gas is purified in the flue gas purification apparatus.

Suitably, in the context of the method according to the invention, at least one plate heat exchanger may be used for the at least one waste-heat exchanger, preferably for the at least two waste-heat exchangers connected in series one after the other, of the waste-heat recovery device. Plate heat exchangers, also known as plate heat transmitters, have to advantage of being able to be built very compactly and have a very high heat flow density relative to their small size, which is why they are used in a wide variety of areas, including for industrial heating and/or cooling tasks and in solar technology.

The objects mentioned at the beginning are also solved with a system for waste-heat recovery according to the invention, wherein the system comprises:
a first process unit, wherein the first process unit comprises at least one heating burner, wherein the at least one heating burner is fluidly connected to at least one fuel supply line and to at least one combustion-air supply line;
a second process unit for generating thermal energy, wherein the second process unit comprises a combustion furnace, wherein the combustion furnace is designed to burn waste materials including sulphur compounds in the operating state of the system to obtain a hot combustion waste gas including sulphur compounds; and
a waste-heat recovery device comprising at least one waste-heat exchanger, wherein the waste-heat recovery device is designed to transfer thermal energy of the hot combustion waste gas discharged from the second process unit in an operating state of the system, which hot combustion waste gas, optionally with admixture of fresh air and/or tertiary air, can be introduced into the waste-heat recovery device by the at least one waste-heat exchanger to a fluid which is provided as an energy source in the first process unit, wherein the combustion waste gas downstream of the at least one waste-heat exchanger has a gas temperature which is higher than a dew-point temperature of the sulphur compounds in the combustion waste gas.

The advantages and beneficial effects mentioned above in the context of the method according to the invention also apply equally to the system for waste-heat recovery according to the invention.

In an advantageous variant of the system according to the invention, the gas temperature of the combustion waste gas downstream of the at least one waste-heat exchanger within the waste-heat recovery device may be at least 130° C., preferably at least 135° C.

A system according to the invention may be particularly efficient if the first process unit is a paper machine, preferably a drying section of a paper machine.

It may be particularly efficient to provide large quantities of thermal energy from non-fossil secondary fuels for waste-heat recovery, if in a system according to the invention the second process unit is an combustor of a pulp mill, wherein the combustor is designed to burn secondary fuels and/or waste materials in the operating state of the system, wherein the waste materials are selected from the group comprising: wood chips, bark waste, fibre sludges, sewage sludges, methanol, bioalcohol, tall oils, turpentines, rich gases and/or non-condensable waste gases.

A system according to the invention, which is designed to, in the operating state of the system, transfer thermal energy from the hot combustion waste gas by the at least one waste-heat exchanger to the combustion-air line for the at least one heating burner in the first process unit in order to heat the combustion supply air supplied to the at least one heating burner in the operating state, may be used particularly flexibly.

A system according to the invention, which is designed to ensure that the gas temperature of the hot combustion waste gas immediately upstream of the waste-heat recovery device, optionally with admixture of fresh air and/or tertiary air, is in a range from 550° C. to 650° C., preferably from 570° C. to 630° C., particularly preferably from 590° C. to 610° C., may be used in a versatile manner. Thus, for example, heat transfer operations in which a fluid of the first process unit is to be heated to temperatures in the range of up to 450° C. may be mastered particularly efficiently.

In a particularly compact variant of the embodiment, the waste-heat recovery device in a system according to the invention may comprise at least one waste-heat recovery line for discharging the hot combustion waste gas from the second process unit, wherein the at least one waste-heat recovery line is fluidly connected to the second process unit and to the at least one waste-heat exchanger, preferably to at least two waste-heat exchangers connected in series one after the other, and wherein a flue gas purification apparatus is connected downstream of the at least one waste-heat exchanger.

A system in which the at least one waste-heat exchanger, preferably at least two waste-heat exchangers connected in series one after the other, of the waste-heat recovery device is/are configured as a plate heat exchanger may be used in a versatile manner.

In order to enable particularly convenient operation, a blower apparatus may be provided in a system according to the invention for controlling a flow rate of the combustion waste gas through the at least one waste-heat exchanger of the waste-heat recovery device, wherein the blower apparatus is fluidly connected to the at least one waste-heat exchanger, and wherein the blower apparatus is preferably arranged downstream of the waste-heat exchanger in the flow direction of the combustion waste gas.

Moreover, a controller for a system for waste-heat recovery is specified in the context of the invention, wherein the controller is designed to perform the following method steps:
discharging of hot combustion waste gas from a second process unit, optionally with admixture of fresh air and/or tertiary air, and introducing into a waste-heat recovery device comprising at least one waste-heat exchanger;
setting a gas temperature of the hot combustion waste gas during introduction from the second process unit into the waste-heat recovery device, optionally with admixture of fresh air and/or tertiary air, to a temperature in the range from 550° C. to 650° C., preferably from 570° C. to 630° C., particularly preferably from 590° C. to 610° C.;
transferring thermal energy from the hot combustion waste gas introduced into the waste-heat recovery device by the at least one waste-heat exchanger to a fluid which is usable as an energy source in a first process unit;
optionally controlling a flow rate of the combustion waste gas through the at least one waste-heat exchanger of the waste-heat recovery device by a blower apparatus; and
Setting a gas temperature of the combustion waste gas downstream of the at least one waste-heat exchanger, the gas temperature not falling below a dew-point temperature of the sulphur compounds in the combustion waste gas, preferably a gas temperature of the combustion waste gas being set to at least 130° C., particularly preferably to at least 135° C.

### SHORT DESCRIPTION OF THE FIGURES

In the following, the invention will be explained in more detail with reference to an exemplary embodiment. The drawing is exemplary and is intended to illustrate the idea of the invention, but in no way to limit it or to represent it conclusively.

In the figure:

FIG. 1 is a schematic representation of a system for waste-heat recovery according to the invention in a process flow diagram.

### WAYS OF REALISING THE INVENTION

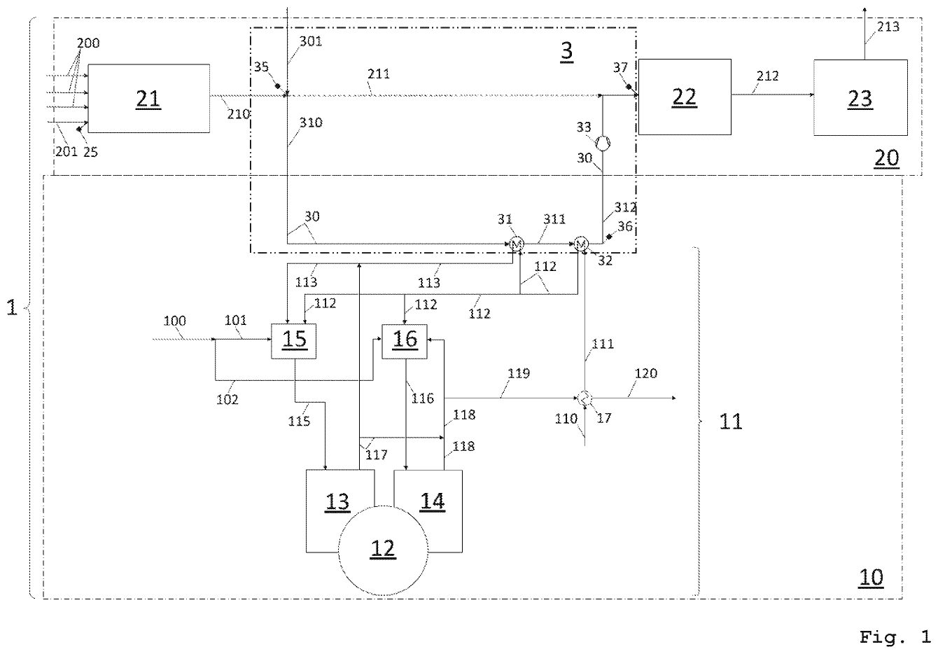

FIG. 1 shows a system 1 for waste-heat recovery based on the heating of a heating burner of a first process unit 10, for example a paper machine 10, in particular a drying section 11 of a paper machine 10. For a better overview, the first process unit 10 is outlined with a dash-dotted line. This is an example of a so-called MG paper machine for the production of paper that is smoothed on one side, wherein in the drying section 11, in the operating state of the paper machine 10, paper is guided over numerous small heated drying cylinders, which are not explicitly depicted in FIG. 1, as well as over a particularly large drying cylinder 12 with a large cylinder diameter, a so-called Yankee cylinder 12, and dried in the process. The drying air required for drying in the area of the Yankee cylinder 12 is provided by a first dryer hood 13 and a second dryer hood 14, wherein the two dryer hoods 13, 14 are arranged to the left/right of a longitudinal axis and above the Yankee cylinder 12.

A first heating burner 15 is used to heat and provide dry hot air for the first dryer hood 13. A second heating burner 16 is used to heat and provide dry hot air for the second dryer hood 14. For example, at least one heat exchanger 17 for preheating fresh air is also present in the drying section 11.

A second process unit 20, which in this example is an combustor 20 of a pulp mill, comprises a combustion furnace 21, a flue gas purification apparatus 22 and an waste gas chimney 23. A quantity sensor 25 is used here to detect the waste quantity flows supplied to the combustion furnace 21 in the operating state. These assemblies and components, which are required to operate the combustor 20, are also outlined with a dash-dotted line for ease of reference.

According to the invention, a waste-heat recovery device 3 is also provided, which in this case comprises a waste-heat recovery line 30 as well as a first waste-heat exchanger 31 and a second waste-heat exchanger 32 connected in series with the first waste-heat exchanger 31. The two waste-heat exchangers 31, 32 are here, for example, each configured as a plate heat exchanger. A blower apparatus 33 is arranged downstream of the two waste-heat exchangers 31, 32. For a better overview, the components of the waste-heat recovery device 3 are outlined with a dash-double dotted line.

Several temperature sensors are used for temperature monitoring and temperature control during operation of system 1. A first temperature sensor 35 is used to monitor the temperature of hot combustion waste gas that is supplied into the waste-heat recovery line 30. A further, second temperature sensor 36 is provided in the waste-heat recovery line 30 downstream of the two waste-heat exchangers 31, 32 connected in series one after the other and is used for temperature monitoring of the gas temperature 36 of combustion waste gas after it leaves the waste-heat exchangers 31, 32. A further, third temperature sensor 37 is arranged downstream of a blower apparatus 33, which is arranged downstream of the two waste-heat exchangers 31, 32. The waste-heat recovery line 30 is fluidly/fluidically connected to the two waste-heat exchangers 31, 32 and to the blower apparatus 33.

The further reference numerals 100 to 312 each equally denote conveying lines, for example pipelines, for supplying and/or discharging the corresponding media, as well as the media conveyed within the respective lines. The directions of the arrows in FIG. 1 refer to the respective conveying directions of the media in the respective lines in the operating state of the system for waste-heat recovery 1 according to the invention.

The reference numerals 100 to 120 described below relate to the first process unit 10/the paper machine 10 shown here.

The two heating burners 15 and 16 are fed by a fuel supply line 100, wherein natural gas, for example, is supplied as fuel 100 to the two heating burners 15, 16 in the direction of arrow 100. The fuel supply line 100 is divided into a first fuel supply line 101 for the first heating burner 15 and a second fuel supply line 102 for the second heating burner 16. Where necessary, the hot air temperatures for heating the first dryer hood 13 and for heating the second dryer hood 14 can be individually controlled by setting the dosing quantities of the respective quantities of natural gas supplied as fuels 101, 102.

In a fresh air supply line 110, fresh air 110 is supplied to the drying section 11 in the direction of arrow 110. The fresh air 110 is preheated in the heat exchanger 17 for fresh air preheating and then passes in a supply line 111 for preheated fresh air 111 in the direction of arrow 111 into the waste-heat exchanger 32, wherein thermal energy is transferred to the preheated fresh air 111 in the waste-heat exchanger 32 and the fresh air 111 is heated in the process. Heated fresh air leaves the waste-heat exchanger 32 in the direction of arrow 112 in the supply line 112 as heated combustion supply air 112, wherein a first partial flow of the heated combustion supply air 112 is used directly to supply the two heating burners 15, 16 with combustion supply air 112. A second partial flow of the heated combustion supply air 112 is fed to another waste-heat exchanger 31. In the waste-heat exchanger 31, thermal energy is again transferred to the already heated combustion supply air 112, wherein the temperature of the combustion supply air 112 is further increased, whereby further heated combustion supply air 113 is obtained downstream the waste-heat exchanger 31. The further heated combustion supply air 113 is supplied here, for example, only to the first heating burner 15, which heating burner 15 heats the first dryer hood 13 of the Yankee cylinder 12, which is located upstream of the second dryer hood 14 as viewed in the upstream direction opposite a conveying direction of the paper web. The first dryer hood 13 is used here to dry a still comparatively moist paper web with about 40% water content, which is why a comparatively larger amount of drying air and/or a comparatively higher temperature of the heated combustion supply air 113 is/are suitable compared to the amount of drying air and/or temperature of the combustion supply air 112 for the downstream second dryer hood 14.

A hot air supply line 115 is used to supply hot air 115 from the first heating burner 15 to the first drying hood 13. A separate hot air supply line 116 is used to supply hot air 116 from the second heating burner 16 to the second drying hood 14.

A waste air line 117 is used to discharge humid waste air 117 from the first dryer hood 13. A waste air line 118 is used to discharge humid waste air 118 from the second dryer hood 14 of the Yankee cylinder 12. Partial flows of the humid waste air 117, 118 may also be recirculated if necessary and supplied back to the heating burners 15, 16. A shared waste air line 119 is used to discharge the humid waste air 119 from the drying section 11. After passing the heat exchanger 17 for fresh air preheating, wherein thermal energy of the humid waste air 119 is transferred to the fresh air 110 to be preheated, cooled outgoing air 120 leaves the drying section 11/the first process unit 10 of the paper machine 10 via an outgoing air discharge line 120 in the direction of arrow 120.

The reference numerals 200 to 213 described below relate to the second process unit 20/the combustor 20 shown here.

One or more fuel supply lines 200 are used to supply secondary fuels 200 for the operation of the combustion furnace 21. A waste material supply line 201 is used for supplying waste materials 201 to be burned in the combustion furnace 21. Wherein waste materials 201 may also be used as fuels 200 due to their energy content or, conversely, secondary fuels 200 may also contain pollutant loads.

A line 210 is used to discharge the hot combustion waste gas 210 from the combustion furnace. The hot combustion waste gas 210 includes sulphur compounds.

The conventional line 211 indicated by dashed line 211 shows the previous line for conveying the hot combustion waste gas to a downstream flue gas purification apparatus 22 according to the prior art. The dashed line 211 is not part of the system 1 according to the invention and is only intended to show an example of a possible previous system design according to the prior art, according to which the second process unit 20 was not connected to the first process unit 10.

The further lines 212 show an waste gas supply line 212 of the purified waste gas to the waste gas chimney 23 and a waste gas discharge line 213 from the waste gas chimney 23.

This variant of the embodiment of the method according to the invention is particularly suitable as a solution for retrofitting existing combustors 20. Instead of a conventional waste gas line 211, in which the combustion waste gas 210 from the combustion furnace 21 passes directly into a downstream flue gas purification apparatus 22 and is thus conducted away unused via chimney 23, in the process control according to the invention the hot combustion waste gas 210 may be conveyed in at least one waste-heat recovery line 30, which is fluidically connected to the second process unit 20/the combustion furnace 21 and to the two waste-heat exchangers 31, 32 connected in series one after the other.

The reference numerals 300 to 312 described below relate to the waste-heat recovery device 30.

Instead of the conventional line 211, here, a fresh air or tertiary air supply line 301 is connected to the hot combustion waste-gas line 210 in order to introduce the hot combustion waste gas 210, optionally with admixture of fresh air and/or tertiary air 301, into a first line section 310 of the waste-heat recovery line 30 of the waste-heat recovery device 3. The hot combustion waste gas 310 including sulphur compounds enters the first waste-heat exchanger 31 and heat energy/thermal energy is transferred from the hot combustion waste gas 310 to the heated combustion supply air 112, wherein the combustion supply air 113 is further heated. Conversely, the hot combustion waste gas 310 is cooled by the heat transfer in the first waste-heat exchanger 31 and enters a line section 311 of the waste-heat recovery line 30 as combustion waste gas 311 that is somewhat cooled compared to the gas temperature 35 of the hot combustion waste gas 310. In the second waste-heat exchanger 32, heat energy/thermal energy is transferred from the combustion waste gas 311 to the preheated fresh air 111. The combustion waste gas 311 is cooled further and enters into a line section 312. The two temperature sensors 36, 37 are used in this line section 312 to control the combustion waste gas temperature 36 of the cooled combustion waste gas 312 to ensure that the gas temperature 36, 37 in the line section 312 is above a dew-point temperature of the sulphur compounds in the combustion waste gas 311.

The line section 312 of the waste-heat recovery line 30 here comprises a blower apparatus 33, wherein the blower apparatus 33 is fluidly connected to the waste-heat exchangers 31, 32 and is arranged downstream thereof in the flow direction 312 of the combustion waste gas 312.

Advantageously, a flow rate of the combustion waste gas 310, 311, 312 through the waste-heat exchangers 31, 32 of the waste-heat recovery device 3 may be controlled by means of the blower apparatus 33.

### LIST OF REFERENCE NUMERALS

1 System for waste-heat recovery
3 Waste-heat recovery device
10 First process unit; paper machine
11 Drying section of a paper machine
12 Drying cylinder; Yankee cylinder
13 First dryer hood
14 Second dryer hood
15 First heating burner for first dryer hood
16 Second heating burner for second dryer hood
17 Heat exchanger for pre-heating of fresh air
20 Second process unit; combustor
21 Combustion furnace
22 Flue gas purification apparatus
23 Waste gas chimney
25 Quantity sensor
30 Waste-heat recovery line
31 First waste-heat exchanger
32 Second waste-heat exchanger
33 Blower apparatus
35 Temperature sensor; gas temperature
36 Temperature sensor downstream of waste-heat exchanger; gas temperature
37 Temperature sensor downstream of blower apparatus; gas temperature
100 Fuel (supply line) for heating burner (arrow)
101 Fuel (supply line) for first heating burner (arrow)
102 Fuel (supply line) for second heating burner (arrow)
110 Fresh air (supply line) (arrow)
111 Preheated fresh air (supply line) (arrow)
112 Heated combustion supply air (supply line) (arrow)
113 Further-heated combustion supply air (supply line) (arrow)
115 Hot air (supply line) for first dryer hood (arrow)
116 Hot air (supply line) for second dryer hood (arrow)
117 Humid waste air (discharge line) from first dryer hood (arrow)
118 Humid waste air (discharge line) from second dryer hood (arrow)
119 Humid waste air (discharge line) (arrow)
120 Outgoing air (discharge line) (arrow)
200 Fuel (supply line) for combustion furnace (arrow)
20 Waste material (supply line) for combustion furnace (arrow)
210 Hot combustion waste gas (discharge line) (arrow)
21 Conventional line combustion waste gas (prior art)
212 Waste gas supply line to the waste gas chimney (arrow)
213 Waste gas discharge line from the waste gas chimney (arrow)
301 Fresh air or tertiary air (supply line) (arrow)
310 Combustion waste gas (supply line), hot waste gas (mixture)
311 Combustion waste gas (supply line), hot waste gas (mixture)
312 Combustion waste gas (supply line), warm waste gas (mixture)

1. A method for recovering waste heat for heating a heating burner, in particular a heating burner (15,16) of a drying section (11) of a paper machine (10), the method comprising the following steps:
providing a first process unit (10) in which thermal energy is required in an operating state of the first process unit (10), wherein the first process unit (10) comprises at least one heating burner (15,16), wherein the at least one heating burner (15,16) is fluidly connected to at least one fuel supply line (100,101,102) and to at least one combustion-air supply line (112,113);
providing a second process unit (20) in which thermal energy is generated in an operating state of the second process unit (20), wherein the second process unit (20) comprises a combustion furnace (21), which combustion furnace (21) is designed to burn secondary fuels (200) and/or waste materials (201) including sulphur compounds in the operating state of the second process unit (20);
combusting of secondary fuels (200) and/or waste materials (201) including sulphur compounds in the combustion furnace (21) of the second process unit (20) to generate hot combustion waste gas (210), wherein the hot combustion gas (210) includes sulphur compounds;
discharging the hot combustion waste gas (210) from the second process unit (20), optionally with admixture of fresh air and/or tertiary air (301), and introducing the hot combustion waste gas (310) into a waste-heat recovery device (3) comprising at least one waste-heat exchanger (31,32);
transferring thermal energy from the hot combustion waste gas (310) introduced into the waste-heat recovery device (3) by the at least one waste-heat exchanger (31,32) to a fluid used as an energy source in the first process unit (10), wherein a gas temperature (36,37) of the combustion waste gas (311,312) downstream of the at least one waste-heat exchanger (31,32) within the waste-heat recovery device (3) is set so as not to fall below a dew-point temperature of the sulphur compounds in the combustion waste gas (311,312).

2. The method according to claim 1, wherein the gas temperature (36,37) of the combustion waste gas (311,312) downstream of the at least one waste-heat exchanger (31,32) within of the waste-heat recovery device (3) is set to at least 130° C., preferably to at least 135° C.

3. The method according to claim 1, wherein a paper machine (10), preferably a drying section (11) of a paper machine (10), is provided as the first process unit (10).

4. The method according to claim 1, wherein an combustor (20) of a pulp mill is provided as the second process unit (20), wherein the combustor (20) is designed to burn secondary fuels (200) and/or waste materials (201) in the operating state, wherein the secondary fuels (200) and/or waste materials (201) are selected from the group comprising: wood chips, bark waste, fibre sludges, sewage sludges, methanol, bioalcohol, tall oils, turpentines, rich gases and/or non-condensable waste gases.

5. The method according to claim 1, wherein thermal energy is transferred from the hot combustion waste gas (310,311) by the at least one waste-heat exchanger (31,32) to the combustion supply air (112,113) for the at least one heating burner (15,16) in the first process unit (10), wherein the combustion supply air (112,113) is heated.

6. The method according to claim 1, wherein a gas temperature (35) of the hot combustion waste gas (310) immediately upstream of the waste-heat recovery device (3), optionally with admixture of fresh air and/or tertiary air (301), is set to a temperature in the range from 550° C. to 650° C., preferably from 570° C. to 630° C., particularly preferably from 590° C. to 610° C.

7. The method according to claim 1, wherein the waste-heat recovery device (3) comprises at least one waste-heat recovery line (30) for discharging the hot combustion waste gas (210) from the second process unit (20), wherein the at least one waste-heat recovery line (30) is fluidly connected to the second process unit (20) and to the at least one waste-heat exchanger (31,32), preferably to at least two waste-heat exchangers (31,32) connected in series one after the other, and wherein a flue gas purification apparatus (22) is arranged downstream of the at least one waste-heat exchanger (31,32), so that the hot combustion waste gas (310,311,312) in the operating state of the second process unit (20) is conveyed through the at least one waste-heat exchanger (31,32), preferably through at least two waste-heat exchangers (31,32) connected in series one after the other, and is cooled in the process before the combustion waste gas (312) is purified (212) in the flue gas purification apparatus (22).

8. The method according to claim 1, wherein at least one plate heat exchanger is used for the at least one waste-heat exchanger (31,32), preferably for the at least two waste-heat exchangers (31,32) connected in series one after the other, of the waste-heat recovery device (3).

9. System (1) for waste-heat recovery, the system (1) comprising:
a first process unit (10), wherein the first process unit (10) comprises at least one heating burner (15,16), wherein the at least one heating burner (15,16) is fluidly connected to at least one fuel supply line (100,101,102) and to at least one combustion-air supply line (112,113);
a second process unit (20) for generating thermal energy, wherein the second process unit (20) comprises a combustion furnace (21), wherein the combustion furnace (21) is designed to burn secondary fuels (200) and/or waste materials (201) including sulphur compounds in the operating state of the system (1) to obtain a hot combustion waste gas (210) including sulphur compounds; and further comprising
a waste-heat recovery device (3) comprising at least one waste-heat exchanger (31,32), wherein the waste-heat recovery device (3) is designed to transfer thermal energy of the hot combustion waste gas (210) discharged from the second process unit (20) in an operating state of the system (1), which hot combustion waste gas (310), optionally with admixture of fresh air and/or tertiary air (301), can be introduced into the waste-heat recovery device (3) by the at least one waste-heat exchanger (31,32) to a fluid which is provided as an energy source in the first process unit (10), wherein the combustion waste gas (311,312) downstream of the at least one waste-heat exchanger (31,32) has a gas temperature (36,37) which is higher than a dew-point temperature of the sulphur compounds in the combustion waste gas (311,312).

10. The system (1) according to claim 9, wherein the gas temperature (36,37) of the combustion waste gas (311,312) downstream of the at least one waste-heat exchanger (31,32) within of the waste-heat recovery device (3) is at least 130° C., preferably at least 135° C.

11. The system (1) according to claim 9, wherein the first process unit (10) is a paper machine (10), preferably a drying section (11) of a paper machine (10).

12. The system (1) according to claim 9, wherein the second process unit (20) is an combustor (20) of a pulp mill, wherein the combustor (20) is designed to burn secondary fuels (200) and/or waste materials (201) in the operating state of the system (1), wherein the secondary fuels (200) and/or waste materials (201) are selected from the group comprising: wood chips, bark waste, fibre sludges, sewage sludges, methanol, bioalcohol, tall oils, turpentines, rich gases and/or non-condensable waste gases.

13. The system (1) according to claim 9, wherein the system (1) is designed to, in the operating state of the system (1), transfer thermal energy from the hot combustion waste gas (310) by the at least one waste-heat exchanger (31,32) to the combustion-air line (112, 113) for the at least one heating burner (15,16) in the first process unit (10) in order to heat the combustion supply air (112,113) supplied to the at least one heating burner (15,16) in the operating state.

14. The system (1) according to claim 9, wherein the system (1) is designed such that a gas temperature (35) of the hot combustion waste gas (310) immediately upstream of the waste-heat recovery device (3), optionally with admixture of fresh air and/or tertiary air (301), is a temperature in the range from 550° C. to 650° C., preferably from 570° C. to 630° C., particularly preferably from 590° C. to 610° C.

15. The system (1) according to claim 9, wherein the waste-heat recovery device (3) comprises at least one waste-heat recovery line (30) for discharging the hot combustion waste gas (210) from the second process unit (20), wherein the at least one waste-heat recovery line (30) is fluidly connected to the second process unit (20) and to the at least one waste-heat exchanger (31,32), preferably to at least two waste-heat exchangers (31,32) connected in series one after the other, and wherein a flue gas purification apparatus (22) is connected downstream of the at least one waste-heat exchanger (31,32).

16. The system (1) according to claim 9, wherein the at least one waste-heat exchanger (31,32), preferably at least two waste-heat exchangers (31,32) connected in series one after the other, of the waste-heat recovery device (3) is/are configured as a plate heat exchanger.

17. The system (1) according to claim 9, wherein a blower apparatus (33) is provided for controlling a flow rate of the combustion waste gas (311,312) by the at least one waste-heat exchanger (31,32) of the waste-heat recovery device (3), wherein the blower apparatus (33) is fluidly connected to the at least one waste-heat exchanger (31,32), wherein the blower apparatus (33) is preferably arranged downstream of the waste-heat exchanger (31,32) in the flow direction (312) of the combustion waste gas (312).

18. Controller for a system (1) for waste-heat recovery according to claim 9, wherein the controller is designed to carry out the following method steps:
discharging of hot combustion waste gas (210) from a second process unit (20) optionally with admixture of fresh air and/or tertiary air (301) and introducing into a waste-heat recovery device (3) comprising at least one waste-heat exchanger (31,32);
Setting a gas temperature (35) of the hot combustion waste gas (310) during introduction from the second process unit (20) into the waste-heat recovery device (3), optionally with admixture of fresh air and/or tertiary air (301), to a temperature in the range from 550° C. to 650° C., preferably from 570° C. to 630° C., particularly preferably from 590° C. to 610° C.;
transferring thermal energy from the hot combustion waste gas (310) introduced into the waste-heat recovery device (3) by the at least one waste-heat exchanger (31,32) to a fluid which can be used as an energy source in a first process unit (10);
optionally controlling a flow rate of the combustion waste gas (311,312) through the at least one waste-heat exchanger (31,32) of the waste-heat recovery device (3) by a blower apparatus (33); and
Setting a gas temperature (36,37) of the combustion waste gas (311,312) downstream of the at least one waste-heat exchanger (31,32), the gas temperature not falling below a dew-point temperature of the sulphur compounds in the combustion waste gas (311,312), preferably a gas temperature (36,37) of the combustion waste gas (311,312) being set to at least 130° C., particularly preferably to at least 135° C.
